(19) United States
(12) Patent Application Publication
(10) Pub. No.: US 2024/0138379 A1
(43) Pub. Date: May 2, 2024

(54) METHODS, SYSTEMS, CLAMPS AND MODULAR COVERS FOR MANIPULATION OF INDIVIDUAL HIVE FRAMES IN A BEE HIVE

(71) Applicant: BEEWISE TECHNOLOGIES LTD., Kibbutz Beit Haemek (IL)

(72) Inventors: Eliyah RADZYNER, Sunnyvale, CA (US); Yossef GREENBLATT, Haifa (IL); Matan FRENKEL, Kiryat Bialik (IL); Yossi SORIN, Clil (IL); Omri AVITAN, Davrat (IL)

(73) Assignee: BEEWISE TECHNOLOGIES LTD., Kibbutz Beit Haemek (IL)

(21) Appl. No.: 18/175,712

(22) Filed: Feb. 28, 2023

Related U.S. Application Data
(60) Provisional application No. 63/381,561, filed on Oct. 30, 2022.

(51) Int. Cl. A01K 47/02; B25J 15/00

(52) U.S. Cl. CPC A01K 47/02; B25J 15/0061

(57) ABSTRACT

A method comprising: (a) lowering two pairs of mechanical rods into inter-frame spaces on each side of a single hive frame in a beehive; (b) decreasing a distance between downward facing jaws of a motorized clamp until said jaws engage and retain the single hive frame; and (c) lifting said motorized clamp.

### RELATED APPLICATIONS

This application claims the benefit according to 35 U.S.C. § 119(e) of U.S. provisional patent application 63/381,561 filed on Oct. 30, 2022 entitled “METHODS, SYSTEMS, AND CLAMPS FOR MANIPULATING INDIVIDUAL HIVE FRAMES IN A BEEHIVE” having the same applicant as the present application; which is fully incorporated herein by reference.

### FIELD OF THE INVENTION

The invention is in the field of beekeeping.

### BACKGROUND OF THE INVENTION

One common design for commercial beehives is top opening boxes with eight to ten hive frames hung vertically from edges of the box. Typically the frames are spaced about 38 mm (center to center). The box most often has a removable cover that conceals the hive frames from view. Each hive frame is a (typically wooden) structure that houses/includes a honeycomb as known in the art.

Each frame includes a top bar, two side bars connected to and descending vertically from the top bar, and a bottom bar connecting the side bars and completing the frame. Hive frames are typically constructed of wood, but may also be constructed of plastic or other materials.

One common hive configuration in the United States employs top bars with a length of about 48 cm. Deep hives have side bars with a length of about 23 cm. Medium hives have side bars with a length of about 16 cm. Shallow hives have side bars with a length of about 14 cm.

Each top bar has an ear at each end. The ears sit on a top edge of the hive box. A hive box typically contains 8 to 10 hive frames, although other configurations are possible.

FIG. 1 is a schematic top view of conventional hive frames in a hive box.

FIG. 1 shows three top bars 110 with ears 114 protruding beyond posts 126 of the side bars. Posts 126 of adjacent frames are typically sealed together by the bees with glue joints 128 made of wax. Posts 126 separate a space 132 between adjacent frames from a space 130 between adjacent ears.

### SUMMARY OF THE INVENTION

According to one aspect of some embodiments of the invention, hive frames are mechanically separated from one another by a mechanized device before being lifted out of a beehive. In some exemplary embodiments of the invention, separation is performed by dedicated separation levers. In some exemplary embodiments of the invention, separation is performed by increasing distance between jaws of a downward facing clamp. According to various exemplary embodiments of the invention 480 Newtons, 490 Newtons, 500 Newtons, 510 Newtons, or 520 Newtons of separation force or intermediate or greater forces are applied.

According to another aspect of some embodiments of the invention, jaws of a pair of downward facing clamps concurrently engage and retain a hive frame in a beehive. In some embodiments the jaws engage and retain a top bar of the hive frame. Alternatively or additionally, in some embodiments the jaws engage and retain a side bar of the hive frame. In some embodiments concurrent engagement of a top bar and side bar contribute to a reduction in likelihood that the fame will break when lifted.

According to another aspect of some embodiments of the invention, a mechanical shaker shakes a hive frame engaged by the jaws of the downward facing clamps. In some embodiments this shaking contributes to a tendency of bees to move away from the hive frame. According to various exemplary embodiments of the invention shaking intensity varies from mild, to moderate, to intense. Alternatively or additionally, in some embodiments shaking duration varies from 1 second to 5 seconds to 10 seconds or intermediate or longer times.

Still another further additional aspect of the invention relates to dividing a cover of a top opening beehive into sections, so that each section has a width corresponding to a hive frame positioned below and parallel to the cover section. This configuration is referred to a “cover per fame” or “CPF”. These terms are used both to refer to the configuration as a whole, and to the individual CPF cover units. The CPF configuration contributes to a reduction in disturbance to bees caused by removing a conventional cover (which covers all of the fames in a hive). A magnitude of the reduction in disturbance to bees increases as the number of hive frames in the hive increases. Alternatively or additionally, the CPF configuration contributes to ease of handling and/or storing a cover when a hive frame is being handled. In some exemplary embodiments of the invention, a CPF is attached to a hive frame such that the CPF and frame can be handled as a single unit. In some embodiments this attachment obviates a need to store a cover when extracting or returning a frame from/to a beehive.

In some exemplary embodiments of the invention, a magnitude of the contribution to ease of handling and/or storing the cover increases as the number of hive frames in the hive increases.

In some exemplary embodiments of the invention, the individual CPF covers included pairs of parallel indentations and/or protuberances on their upper edge. According to these embodiments, the pairs of parallel indentations/protuberances contribute an ability of a mechanical device to engage and manipulate the individual CPF unit. In some embodiments two pairs of parallel indentations/protuberances are position proximal to the two ends of the individual CPF unit. Alternatively or additionally, in some embodiments the individual CPF units are provided with pairs of parallel downward extending tabs which engage and retain opposite sides of a top bar of a hive frame covered by the CPF unit. In some exemplary embodiments of the invention, a CPF is attached to a frame (e.g. by glue staples, screws, rivets or other connectors) or integrally formed therewith. In some exemplary embodiments of the invention, the parallel downward extending tabs are positioned below the parallel indentations. According to these embodiments, the tabs impede bees from exiting the hive through the indentions when the individual CPF units are in a closed position on top of the hive.

Alternatively or additionally, in some embodiments individual CPF units include a convex ridge extending along at least a portion of a length of one edge and a corresponding concave groove extending along at least a portion of a length of another edge. According to these embodiments, when the individual CPF units are assembled into a contiguous cover, the convex ridge of one unit is seated in the convex groove of an adjacent unit.

Alternatively or additionally, in some embodiments individual CPF units include elastic flanges along at least one axial edge that contribute to formation of a seal between adjacent individual CPF units assembled into a contiguous cover.

It will be appreciated that the various aspects described above relate to solution of technical problems associated with breakage of hive frames during manipulation.

Alternatively or additionally, it will be appreciated that the various aspects described above relate to solution of technical problems related to a tendency of bees to exit the hive together with an extracted hive frame. Specifically, in some embodiments shaking of the frame during removal detaches bees from the frame. In some embodiments shaking contributes to a reduction in the need for a “smoker” or other device to stun the bees.

Alternatively or additionally, it will be appreciated that the various aspects described above relate to solution of technical problems related to a tendency of bees to become agitated when the hive is uncovered.

In some exemplary embodiments of the invention there is provided a method including: (a) lowering two pairs of mechanical rods into inter-frame spaces on each side of a single hive frame in a bee hive; and (b) activating a motor connected to a drive train that increases a distance between rods in each pair. In some embodiments the rods are provided as downward facing jaws of a motorized clamp. Alternatively or additionally, in some embodiments the drive train pushes each of the rods with a force of at least 450 Newtons. Alternatively or additionally, in some embodiments the method includes: decreasing a distance between downward facing jaws of a motorized clamp until the jaws engage and retain the single hive frame; and lifting the motorized clamp. Alternatively or additionally, in some embodiments the inter-frame spaces are between adjacent ears of top bars of hive frames in the beehive. Alternatively or additionally, in some embodiments the inter-frame spaces are between adjacent top bars of hive frames proximal to side bars of the hive frames in the beehive. Alternatively or additionally, in some embodiments the inter-frame spaces are between central portions of top bars of the hive frames. Alternatively or additionally, in some embodiments the method includes using a twin lead screw for and decreasing the distance. Alternatively or additionally, in some embodiments the method includes using a rocker arm mechanism for decreasing the distance. Alternatively or additionally, in some embodiments the method includes using a linear actuator mechanism for decreasing the distance. Alternatively or additionally, in some embodiments the method includes using a moving ring actuator for decreasing the distance. Alternatively or additionally, in some embodiments the method includes shaking the hive frame while the jaws of the motorized clamp engage the hive frame.

In some exemplary embodiments of the invention there is provided a method including: (a) inserting at least one pair of downward facing jaws of a motorized clamp into spaces between adjacent hive frames in a beehive; (b) increasing a distance between the jaws in each of the at least one pairs, then decreasing the distance until the jaws engage and retain a single hive frame; and (c) lifting the motorized clamp. In some embodiments the method includes lowering the downward facing jaws after the increasing a distance and before the decreasing a distance. Alternatively or additionally, in some embodiments the method includes maintaining contact between the jaws and a sidebar of the hive frame during the lifting. Alternatively or additionally, in some embodiments the at least one pair of downward facing jaws comprises two pairs of downward facing jaws. Alternatively or additionally, in some embodiments the spaces are between adjacent ears of top bars of the hive frames. Alternatively or additionally, in some embodiments the spaces are between adjacent top bars of the hive frames proximal to side bars of the hive frames. Alternatively or additionally, in some embodiments the spaces are between central portions of top bars of the hive frames. Alternatively or additionally, in some embodiments the method includes using a twin lead screw for increasing the distance and decreasing the distance. Alternatively or additionally, in some embodiments the method includes using a rocker arm mechanism for increasing the distance and decreasing the distance. Alternatively or additionally, in some embodiments the method includes using a linear actuator mechanism for increasing the distance and decreasing the distance. Alternatively or additionally, in some embodiments the method includes using a moving ring actuator for increasing the distance and decreasing the distance. Alternatively or additionally, in some embodiments the method includes shaking the hive frame while the jaws of the motorized clamp engage the hive frame. Alternatively or additionally, in some embodiments the method includes using a robotic arm attached to the at least one pair of jaws to transfer the hive frame to a processing unit. Alternatively or additionally, in some embodiments the processing unit includes one or more members of the group consisting of an analytic module, a treatment module and a centrifuge. Alternatively or additionally, in some embodiments the method includes using a robotic arm attached to the at least one pair of jaws to transfer the hive frame from the processing unit back to the beehive.

In some exemplary embodiments of the invention there is provided a motorized clamp equipped with a pair of downward facing jaws, each of the jaws including: a first downward extending member with a length greater than a thickness of a top bar of a hive frame; and a second member, perpendicular to the first member and extending from an outer surface thereof having a notch sized to engage an outer edge of a side bar of the hive frame, the notch formed by a side of the first member and a block extending from an inner side of the second member. In some embodiments the block is sized to touch an ear of the top bar when the outer edge of the side bar is engaged by the notch. Alternatively or additionally, in some embodiments the motorized clamp includes a twin lead screw in operative connection with each jaw in the pair of downward facing jaws. Alternatively or additionally, in some embodiments the motorized clamp includes rocker arms in operative connection with each jaw in the pair of downward facing jaws. Alternatively or additionally, in some embodiments the motorized clamp includes a linear actuator mechanism in operative connection with each jaw in the pair of downward facing jaws.

In some exemplary embodiments of the invention there is provided a system including: a beam with two motorized clamps positioned thereupon, each clamp having a pair of downward facing jaws and a clamp motor; a motorized drive train operatively connected to the beam to cause linear translation of the beam with 2 degrees of freedom; and a controller programmed to position the beam over a hive frame, lower the beam until the jaws enter spaces on either side of the frame, decrease a distance between the jaws in each of the two motorized clamps until the jaws engage and retain the hive frame and raise the beam. In some embodiments the system includes two pairs of downward facing mechanical rods protruding from a bottom face of the beam; and a motor connected to a drive train that increases a distance between rods in each pair. Alternatively or additionally, in some embodiments the controller is programmed to increase a distance between the jaws in each of the two motorized clamps prior to the decreasing. Alternatively or additionally, in some embodiments the system includes a twin lead screw in operative connection with each jaw in the pair of downward facing jaws. Alternatively or additionally, in some embodiments the system includes rocker arms in operative connection with each jaw in the pair of downward facing jaws. Alternatively or additionally, in some embodiments the system includes a linear actuator mechanism in operative connection with each jaw in the pair of downward facing jaws. Alternatively or additionally, in some embodiments the system includes a ring actuator mechanism. Alternatively or additionally, in some embodiments the system includes a shaker mechanism operatively connected to the clamps, the shaker mechanism under operative control of the controller.

In some exemplary embodiments of the invention there is provided a bee hive cover includes: a plurality of cover per frame (CPF) units, each unit having: a length sufficient to span a width of the beehive; and a width corresponding to a width of a hive frame of the beehive; wherein a number of units in the plurality corresponds to a number of hive frames in the beehive. In some embodiments each CPF unit includes a downward extension at each end. Alternatively or additionally, in some embodiments each CPF unit includes: at least one pair of indentations on an upper edge thereof. Alternatively or additionally, in some embodiments some CPF units include two pairs of parallel indentations on opposite edges thereof positioned proximal to the two ends of the CPF unit. Alternatively or additionally, in some embodiments each CPF unit includes: pairs of parallel downward extending tabs designed and configured to engage and retain opposite sides of a top bar of a hive frame covered by the CPF unit. Alternatively or additionally, in some embodiments each CPF unit includes: a convex ridge extending along at least a portion of a length of one axial edge; and a corresponding concave groove extending along at least a portion of a length of an opposite axial edge. Alternatively or additionally, in some embodiments each CPF unit includes: an elastic flange along at least one axial edge thereof. Alternatively or additionally, in some embodiments each CPF unit includes: an elastic flange along both axial edges thereof.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not limiting.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office. Thus, any recitation that an embodiment “includes” or “comprises” a feature is a specific statement that sub embodiments “consist essentially of” and/or “consist of” the recited feature.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

The phrase “adapted to” as used in this specification and the accompanying claims imposes additional structural limitations on a previously recited component.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Implementation of the method and system according to embodiments of the invention involves performing or completing selected tasks or steps manually, automatically, or a combination thereof. Moreover, according to actual instrumentation and equipment of exemplary embodiments of methods, apparatus and systems of the invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is a schematic top view of hive frames in a hive box;

FIG. 2 is a schematic representation of a system according to some embodiments of the invention;

FIG. 3 is a top perspective view of a clamp with downward facing jaws according to some exemplary embodiments of the invention;

FIG. 4 is a bottom perspective view of a clamp with downward facing jaws according to additional exemplary embodiments of the invention;

FIG. 5 is a top perspective view of a clamp with downward facing jaws according to further additional exemplary embodiments of the invention;

FIG. 6 is perspective view from below of a clamp with downward facing jaws according to further additional exemplary embodiments of the invention with a separate separation mechanism;

FIG. 7 is a side perspective view of a shaker mechanism according to some exemplary embodiments of the invention;

FIG. 8 is a flow diagram of a method according to some exemplary embodiments of the invention;

FIG. 9 is a flow diagram of a method according to additional exemplary embodiments of the invention;

FIG. 10a is a side view of a motorized clamp according to some exemplary embodiments of the invention;

FIG. 10b is a perspective view from the end of jaws of the motorized clamp of FIG. 10a engaging an ear of a top bar and a side bar of a hive frame;

FIG. 10c is a top view of jaws of the motorized clamp of FIG. 10a engaging an ear of a top bar and a side bar of a hive frame;

FIG. 11a is an additional schematic representation of a system according to some embodiments of the invention;

FIG. 11b is a diagram of computer system architecture according to some embodiments of the invention;

FIG. 12 is a top perspective view of a pair of clamps according to an exemplary embodiment of the invention position on a conventional bee hive including hive frames;

FIG. 13 is a side perspective view from above of a cover for an individual hive frame according to an exemplary embodiment of the invention;

FIG. 14a is a side perspective view from above of a cover for an individual hive frame according to another exemplary embodiment of the invention;

FIG. 14b is a side perspective view from above of a cover for an individual hive frame according to the embodiment of FIG. 14a attached to a hive frame; and

FIG. 14c is a perspective view from above of a series of covers for individual hive frames according to the embodiment of FIG. 14a engaging one another.

### DETAILED DESCRIPTION OF EMBODIMENTS

Embodiments of the invention relate to methods, systems and motorized clamps designed and configured for extraction of individual hive frames from a bee hive.

Specifically, some embodiments of the invention can be used to safely extract a honey laden frame without compromising its integrity and/or to reduce a need to stun bees during extraction of the frame.

The principles and operation of methods, systems and motorized clamps according to exemplary embodiments of the invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

System Overview

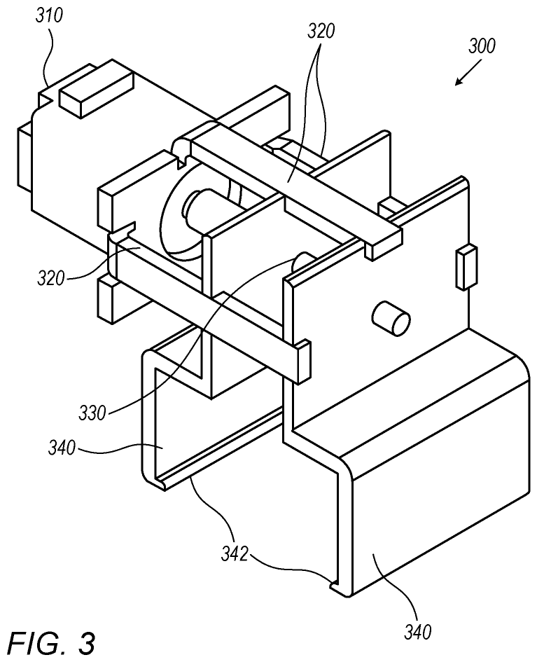

FIG. 2 is a schematic representation of a frame manipulation system, indicated generally as 200, according to some embodiments of the invention.

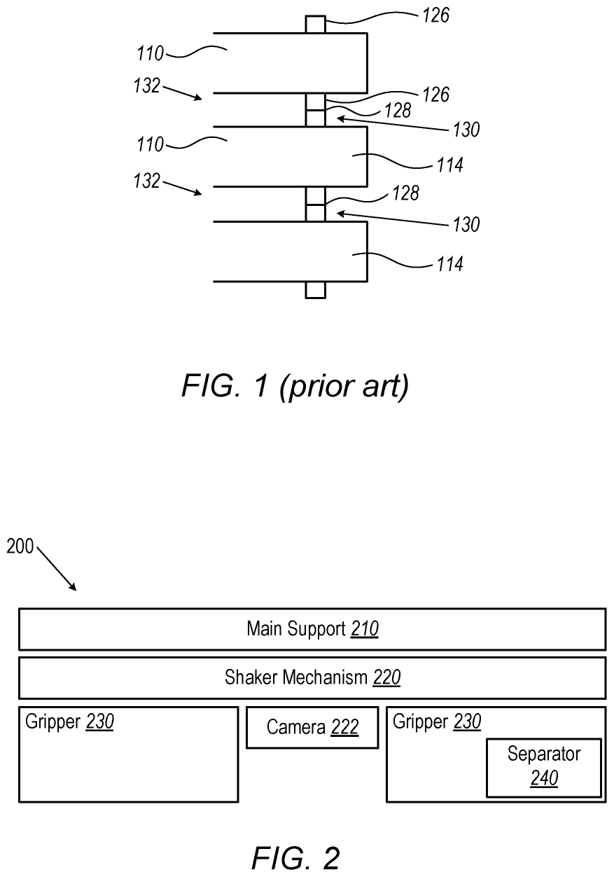

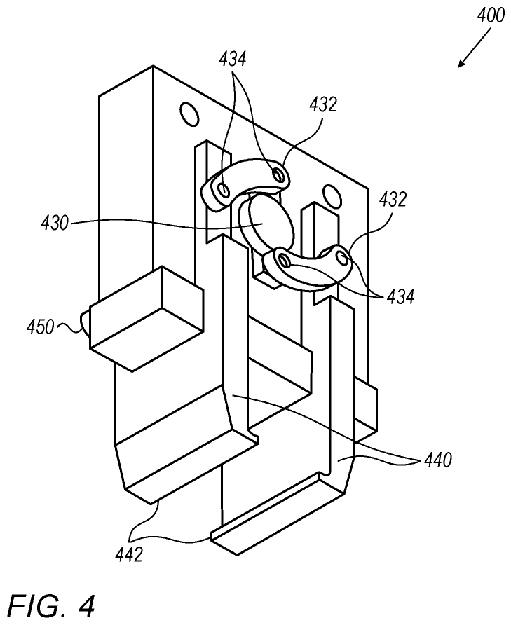

In the depicted embodiment, a main support 210 carries two frame grippers 230 at (or near) opposite ends thereof. In some exemplary embodiments of the invention, frame grippers 230 each include a pair of downward facing jaws. In some embodiments a motor (not depicted) decreases and/or increases a distance between the jaws. Examples of various types of grippers 230 are depicted in FIGS. 3, 4, 5, 6, 10a,10b, and 10c which are described in detail hereinbelow. Frame grippers 230 engage and retain a top bar 110 (FIG. 1) of a hive frame at or near the place where it forms a junction with a side bar. (e.g. at ears 114 and/or at posts 126 and/or just inside posts 126; see FIG. 1). In order to engage and retain the top bar, the gripper motor decreases a distance between the jaws. Once grippers 230 engage and retain top bar 110, lifting of main support 210 lifts top bar 110 and the frame is removed from the hive. In some embodiments contact of grippers 230 with posts 126 contributes to an increase in frame integrity as the frame is lifted from the hive. In some exemplary embodiments of the invention, lifting of main support 210 is by a motorized mechanism (not depicted).

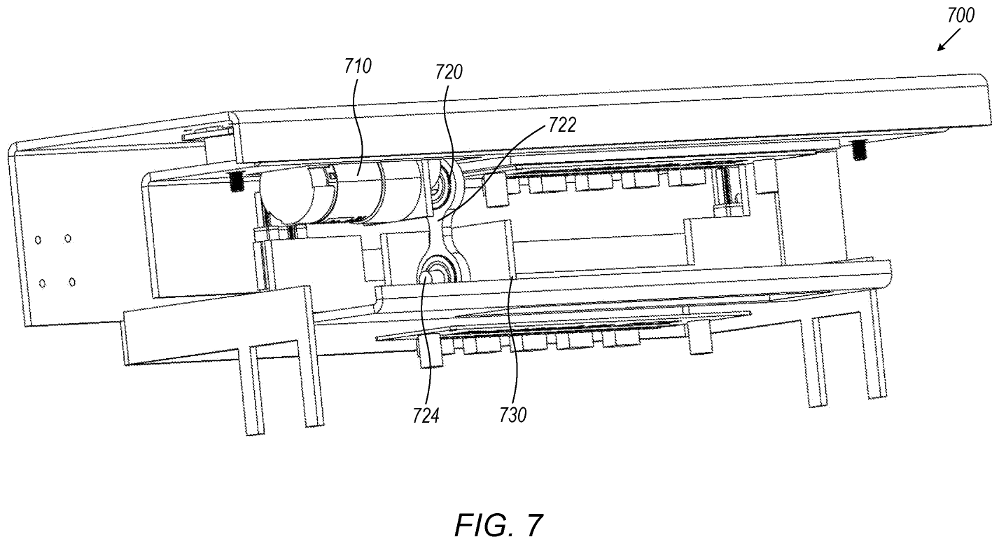

FIG. 2 also depicts separators 240. In some embodiments separators 240 are an integral part of grippers 230 as described hereinbelow. In other exemplary embodiments of the invention (e.g. FIG. 6), separators 240 are a separate mechanism from grippers 230. In some embodiments separators contain a pair of protrusions downward from main support 210. According to various exemplary embodiments of the invention, a motor moves the protrusions apart with sufficient force and amplitude to push adjacent hive frames away and break glue joints 128. This frees a hive frame to be gripped and lifted out of the hive.

In some embodiments system 200 includes a shaker mechanism 220. When grippers 230 engage a top bar of a hive frame and shaker mechanism 220 is activated, the frame shakes and bees on the frame move off of it. In some embodiments this shaking contributes to a reduction in the need to stun bees as the hive frame is removed from the hive.

According to various exemplary embodiments of the invention the intensity of shaking provided by mechanism 220 varies from mild, to moderate, to intense. Alternatively or additionally, according to various exemplary embodiments of the invention duration of shaking by mechanism 220 varies from 1 second to 5 seconds to 10 seconds or intermediate or longer times. In the depicted embodiment, mechanism 220 is provided with a camera 222. In some embodiments camera 222 captures images of a surface of a hive in a hive frame held by grippers 230 from an angle at which bees on the hive are visible. According to these embodiments, image analysis software in a CPU of camera 222 provides an output signal to shaker mechanism 220. For example, if the number of bees on the frame in the image is above a predetermined threshold the signal indicates continuation of shaking and/or an increase is shaking frequency and/or an increase in shaking amplitude and/or an increase in shaking acceleration. Conversely, if the number of bees on the frame in the image is below a predetermined threshold the signal indicates a decrease in shaking frequency and/or a decrease in shaking amplitude and/or shaking deceleration or cessation of shaking. According to these embodiments, shaker mechanism 220 responds to the output signal from the CPU of camera 222.

Exemplary Gripper Configurations

In many exemplary embodiments of the invention, grippers 230 are configured as clamps with downward facing jaws.

FIG. 3 is a top perspective view of a clamp, indicated generally as 300, with downward facing jaws according to some exemplary embodiments of the invention.

In the depicted embodiment, motor 310 drives a twin lead screw 330. Operation of twin lead screw 330 increases/decreases a distance between jaws 340. In the depicted embodiment, jaws 340 are equipped with engagement ridges 342 to accommodate a lower edge of a top bar. In the depicted embodiment, jaws 340 move along guides 320. In some embodiments increasing a distance between jaws 340 until they meet and push adjacent top bars performs the function of separator 240.

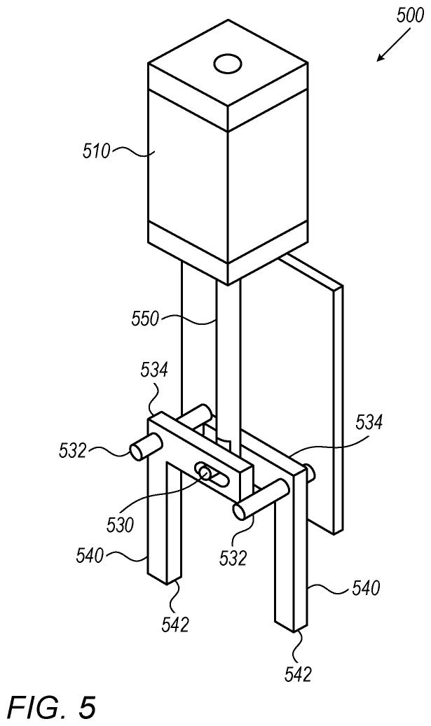

FIG. 4 is a bottom perspective view of a clamp with downward facing jaws, indicated generally as 400, according to additional exemplary embodiments of the invention.

In the depicted embodiment, a motor rotates a drive train connected to drive train interface 450. Rotation of the drive train causes rotation of rotating base 430 which pushes or pulls rocker arms 432. Rocker arms 432 are connected via connectors 434 to rotating base 430 at one end and jaws 440 at the other end. Motion of the rocker arms is translated to linear motion of jaws 440 so that a distance between them either increases or decreases. In the depicted embodiment, jaws 440 are equipped with engagement ridges 442 to accommodate a lower edge of a top bar. In some embodiments increasing a distance between jaws 440 until they meet and push adjacent top bars performs the function of separator 240.

In the depicted embodiment, a distance between jaws 440 increases as rotating base 430 rotates counterclockwise, and decreases as rotating base 430 rotates clockwise.

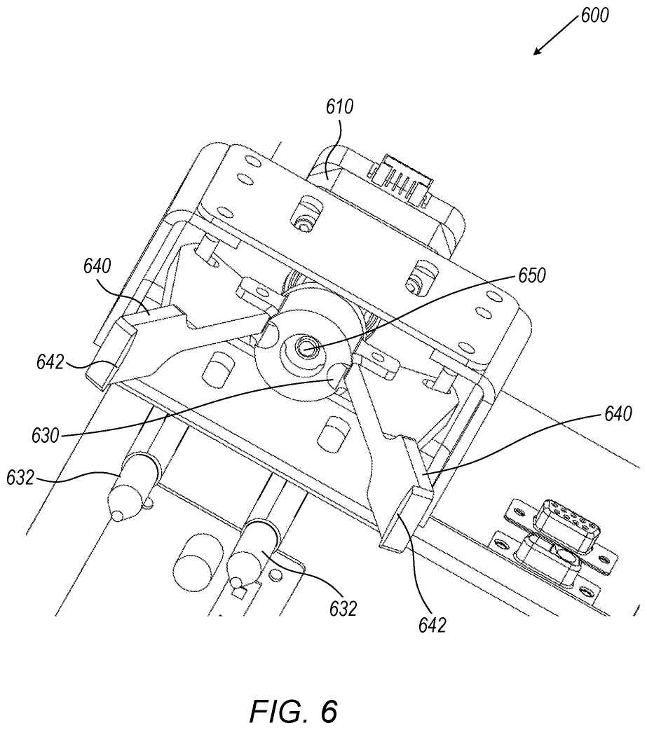

FIG. 5 is a top perspective view of a clamp with downward facing jaws, indicated generally as 500, according to further additional exemplary embodiments of the invention.

In the depicted embodiment, a motor 510 raises and lowers a drive train 550 connected to a linear actuator 530. Linear motion of the drive moves connectors 534 about rocker axles 532 and causes a distance between distal ends 542 of jaws 540 to increase (if actuator 530 rises) or decrease (if actuator 530 descends). In some embodiments increasing a distance between jaws 540 until they meet and push adjacent top bars performs the function of separator 240. Alternatively or additionally, in some embodiments decreasing a distance between jaws 540 allows distal ends 542 to firmly grip a hive frame.

FIG. 6 is perspective view from below of a clamp with downward facing jaws according to further additional exemplary embodiments of the invention with a separate separation mechanism indicated generally as 600.

In the depicted embodiment, a motor 610 raises and lowers a drive train 650 connected to a ring actuator 630. Linear motion of the actuator 630 causes a distance between jaws 640 to increase (if actuator 630 rises) or decrease (if actuator 630 descends). In the depicted embodiment, jaws 640 are equipped with engagement ridges 642 to accommodate a lower edge of a top bar.

In the depicted embodiment, the function of separator 240 (FIG. 2) is performed by downward protrusions 632 which are driven by a motor (not depicted). In some embodiments lowering of protrusions 632 (e.g., by lowering mechanism 600) to position them between top bars of adjacent hive frames. Alternatively or additionally, in some embodiments both of protrusions 632 are moved perpendicularly to a top bar of a hive frame between them in the plane of the top bar. In some embodiments the perpendicular motion is achieved by moving the mechanism 600 in its entirety. This perpendicular motion causes the hive frame between protrusions 632 to move sideways, forcefully pushing aside an adjacent hive frame.

Perpendicular motion of protrusions 632 of protrusions 632 in the opposite direction pushes aside an adjacent hive frame on the opposite side. In some embodiments after adjacent hive frames on both sides of a target hive frame, protrusions 632 push the target frame to its original position for lifting.

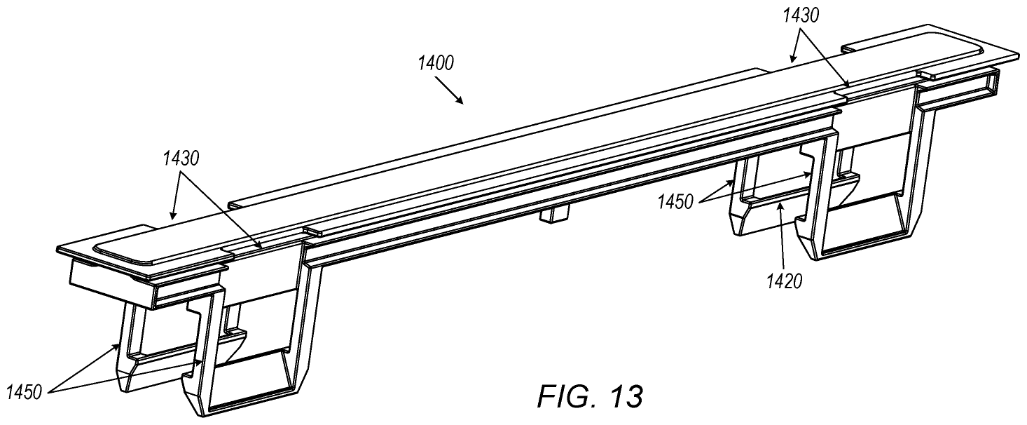

FIG. 12 is a top perspective view of a pair of clamps 600 according to an exemplary embodiment of the invention positioned on conventional hive frames in a bee hive. In the drawing hive frame 1301 is a target frame and frames 1300 and 1302 are adjacent frames.

Perpendicular motion of clamps 600 with respect to target frame 1301 along line 1310 moves adjacent frames 1300 or 1302 depending on the direction.

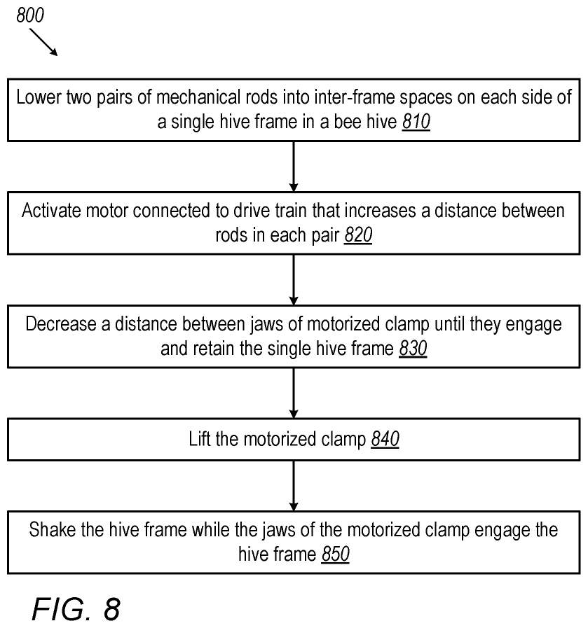

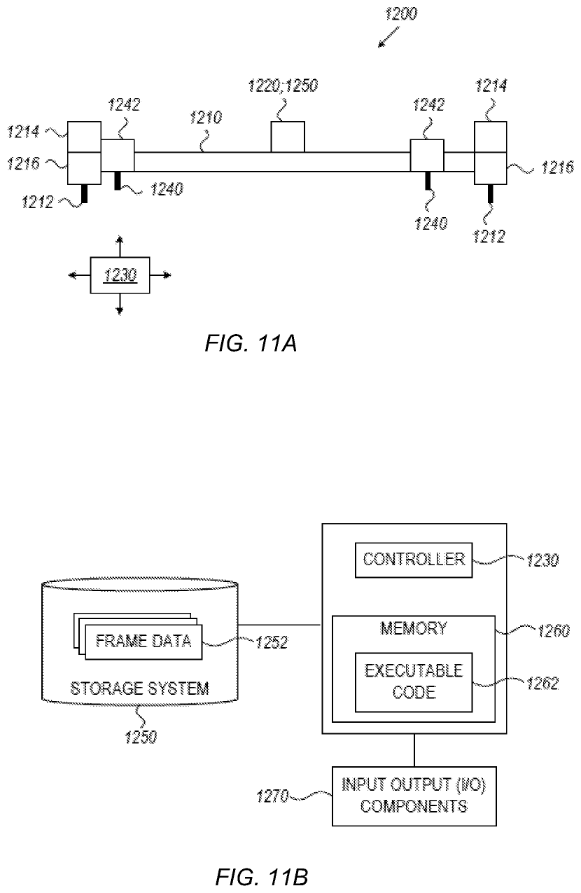

After clamps 600 engage target frame 1301, the frame can is raised using a suitable mechanical mechanism as indicated by 1320. Although clamps 600 (FIG. 6) are depicted, other clamp configurations as depicted in FIG. 3, FIG. 4, FIG. 5, FIG. 10a, FIG. 10b, or FIG. 10c are used in other exemplary embodiments of the invention. In some embodiments as target frame 1301 is raised, it is shaken as described hereinbelow in the context of FIG. 7.

Exemplary Shaker Mechanism

FIG. 7 is a side perspective view of a shaker mechanism, indicated generally as 700, according to some exemplary embodiments of the invention.

Although mechanism 700 is presented here in isolation, it is typically provided in conjunction with frame grippers 230 and/or separators 240 (as depicted schematically in FIG. 2). Activation of shaker mechanism 700 shakes target frame 1301 (FIG. 12) when lifted and gripped by grippers or clamps, e.g., as depicted in in FIG. 3, FIG. 4, FIG. 5, FIG. 6, FIG. 10a, FIG. 10b, or FIG. 10c. In some embodiments these grippers or clamps are included in, or attached to, shaker mechanism 700. According to various exemplary embodiments of the invention example, shaker mechanism 700 shakes target frame 1301 up and down and/or along its length and/or perpendicular to its length. According to various exemplary embodiments of the invention grippers and/or separators are as depicted in FIG. 3, FIG. 4, FIG. 5, FIG. 6, FIG. 10a, FIG. 10b, or FIG. 10c and described herein.

In the depicted embodiment, a motor 710 drives an eccentric gear 720 connected via a connecting rod 722 to an axle 724 affixed to shaker platform 730.

Increasing a speed at which motor 710 turns eccentric gear 720 contributes to an increase in shaking frequency of platform 730. Alternatively or additionally, increasing a degree of eccentricity of gear 720 and/or increasing a length of connecting rod 722 each contribute to an increase in shaking amplitude.

In some embodiments frame grippers and/or separators are mounted on an underside of shaker platform 730.

Exemplary Method

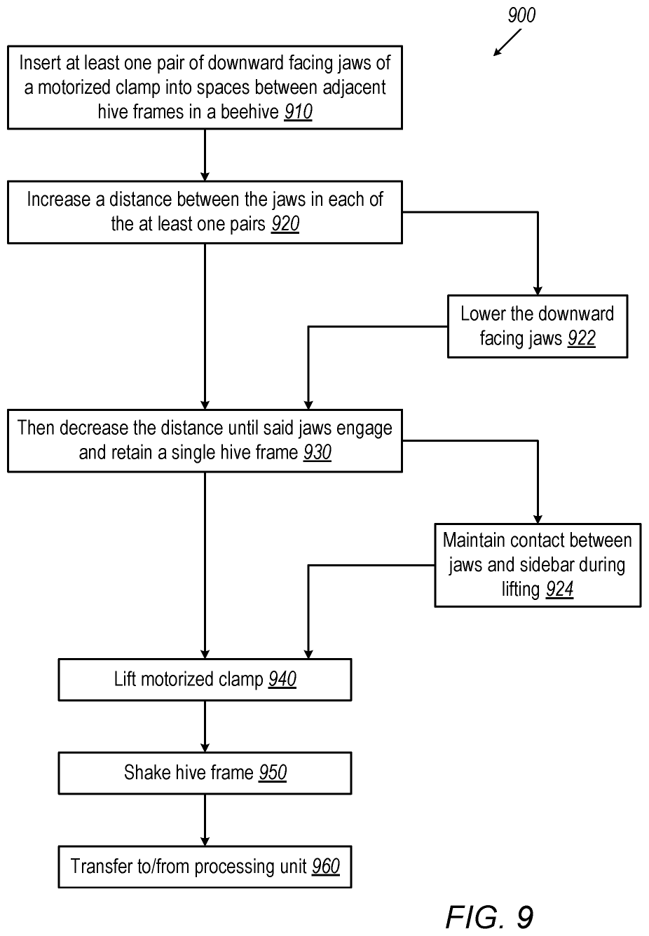

FIG. 8 is a flow diagram of a hive frame separation method, indicated generally as 800, according to some exemplary embodiments of the invention.

Depicted exemplary method 800 includes lowering 810 two pairs of mechanical rods into inter-frame spaces on each side of a single hive frame in a bee hive. In some embodiments concurrent use of two pairs of rods contributes to a reduction in frame damage. Alternatively or additionally, in various embodiments the rods are lowered either into spaces 132 in proximity (e.g. 1 cm, 2 cm, 3 cm, 5 cm, 7.5 cm, 10 cm, 15 cm or intermediate or greater distances) to posts 126 (see FIG. 1) or into spaces 130 between ears 114 (see FIG. 1) or into spaces between central portions of top bars 110 of the hive frames.

In the depicted embodiment, method 800 includes activating 820 a motor connected to a drive train that increases a distance between rods in each pair. In some exemplary embodiments of the invention, the drive train pushes each of said rods with a force of at least 450 Newtons. In some embodiments the applied force is sufficient to break glue joints 128 (FIG. 1).

In some embodiments the rods are provided as downward facing jaws of a motorized clamp (see for example FIGS. 3, 4, 5 and 10a, 10b and 10c). In other exemplary embodiments of the invention, the rods are not part of a motorized clamp as depicted in FIG. 6.

In some exemplary embodiments of the invention, method 800 includes decreasing 830. a distance between jaws of a motorized clamp until the jaws engage and retain the single hive frame. Exemplary clamp configurations are depicted in FIGS. 3, 4, 5, 6 and 10a, 10b and 10c. In the depicted embodiment, method 800 includes lifting 840 the motorized clamp. At this stage the top bar of the frame is raised since it is held by two camps at opposite ends. As a result, the entire hive frame is lifted.

In some exemplary embodiments of the invention, a twin lead screw is used for decreasing 830, for example as depicted in FIG. 3. In some exemplary embodiments of the invention, a rocker arm mechanism is used for decreasing 830 for example as depicted in FIG. 4. In some exemplary embodiments of the invention, a linear actuator mechanism is used for decreasing 830 for example as depicted in FIG. 5. In some exemplary embodiments of the invention, a moving ring actuator is used for decreasing 830 for example as depicted in FIG. 6.

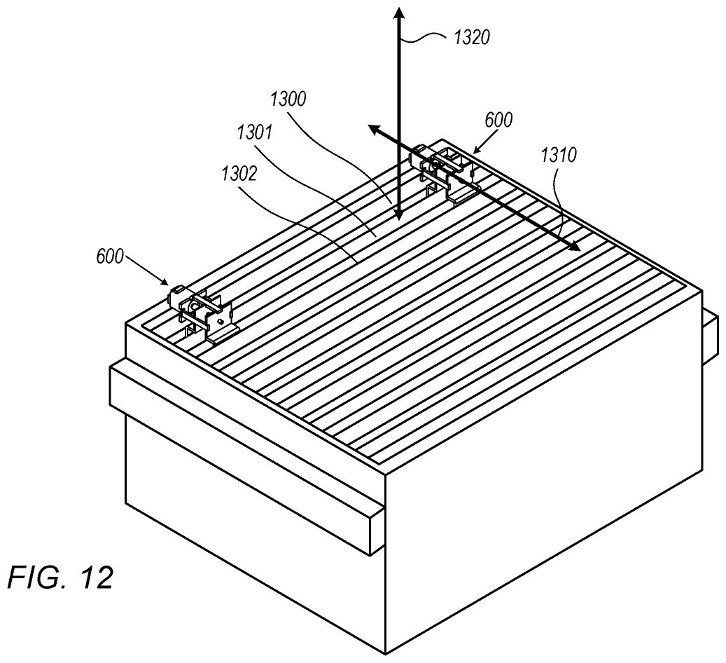

Alternatively or additionally, in some embodiments method 800 includes shaking the hive frame while the jaws of the motorized clamp engage said hive frame. An exemplary shaker mechanism is described in the context of FIG. 7. In some exemplary embodiments of the invention, the shaker mechanism 700 is controlled by a controller. In some embodiments controller 1230 (FIG. 11a) performs this function. Alternatively or additionally, in some embodiments the shaker mechanism has a dedicated controller (not depicted).

In some exemplary embodiments of the invention, the controller controls a frequency with which a target hive frame is shaken and/or an amplitude of shaking and/or a direction of shaking and/or a duration of shaking. In some exemplary embodiments of the invention, assembly 700 includes a camera that acquires images of a frame gripped and lifted as described. In some embodiments images of the gripped frame are analyzed by a data processor equipped with image analysis software. In some embodiments the software determines whether or not (or how many) bees are present on the frame, and shaking of the frame continues until no bees (or a number of bees below a preset maximum) are present on the frame.

Additional Exemplary Method

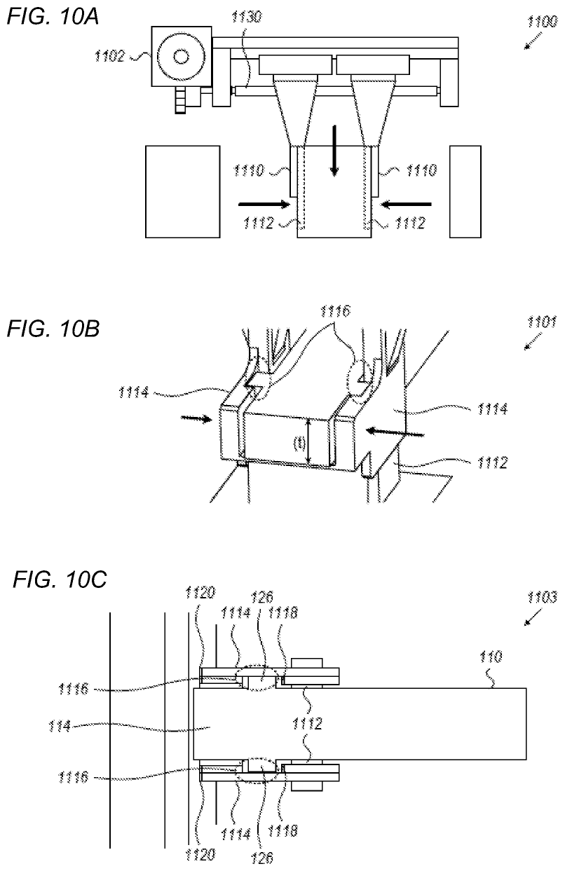

FIG. 9 is a flow diagram of a hive frame removal method, indicated generally as 900, according to additional exemplary embodiments of the invention.

Depicted exemplary method 900 includes inserting 910 at least one pair of downward facing jaws of a motorized clamp into spaces between adjacent hive frames in a beehive. In various embodiments the jaws are lowered either into spaces 132 in proximity (e.g. 1 cm, 2 cm, 3 cm, 5 cm, 7.5 cm, 10 cm, 15 cm or intermediate or greater distances) to posts 126 (see FIG. 1) or into spaces 130 between ears 114 (see FIG. 1) or into spaces between central portions of top bars 110 of the hive frames.

In the depicted embodiment, method 900 includes increasing 920 a distance between the jaws in each of the at least one pairs, then decreasing 930 the distance until the jaws engage and retain a single hive frame and lifting 940 the motorized clamp.

In some exemplary embodiments of the invention, method 900 includes lowering 922 the downward facing jaws after increasing 920 and before decreasing 930. In some embodiments lowering 922 contributes to an ability of the clamp to effectively engage a sidebar of the frame in its jaws. See, for example FIGS. 10a, 10b and 10c, and explanations thereof, in this regard.

In some exemplary embodiments of the invention, method 900 includes maintaining 924 contact between the jaws and a sidebar of the hive frame during lifting 940.

In some embodiments the at least one pair of downward facing jaws comprises two pairs of downward facing jaws. This arrangement is depicted schematically in FIG. 2 where grippers 230 are functionally equivalent to the jaws of method 900.

In some exemplary embodiments of the invention, a twin lead screw is used for increasing 920 and decreasing 930, for example as depicted in FIG. 3. In some exemplary embodiments of the invention, a rocker arm mechanism is used for increasing 920 and decreasing 930 for example as depicted in FIG. 4. In some exemplary embodiments of the invention, a linear actuator mechanism is used for increasing 920 and decreasing 930 for example as depicted in FIG. 5. In some exemplary embodiments of the invention, a moving ring actuator is used for increasing 920 and decreasing 930 for example as depicted in FIG. 6.

Alternatively or additionally, in some embodiments method 900 includes shaking 950 the hive frame while the jaws of said motorized clamp engage said hive frame. An exemplary shaker mechanism is described in the context of FIG. 7.

In some exemplary embodiments of the invention, method 900 includes using a robotic arm attached to the at least one pair of jaws (e.g. via main support 210; FIG. 1) to transfer 960 the hive frame to/from a processing unit. According to various exemplary embodiments of the invention, the processing unit includes an analytic module and/or a treatment module and/or a centrifuge. In some exemplary embodiments of the invention, the processing unit includes an inspection unit that can inspect a honeycomb using sensors such as a camera, a chemical sensor, a sound sensor, weighing scale, a motion sensor etc. In some embodiments the sensors' readings are sent to the CPU and stored in a storage system or reported to the user.

Additional Exemplary Gripper Configuration

FIG. 10a is a side view of a motorized clamp, indicated generally as 1100, according to some exemplary embodiments of the invention.

FIG. 10b is a perspective view from the end, indicated generally as 1101, of jaws of the motorized clamp of FIG. 10a engaging an ear of a top bar and a side bar of a hive frame.

FIG. 10c is a top view, indicated generally as 1103, of jaws of the motorized clamp of FIG. 10a engaging an ear of a top bar and a side bar of a hive frame.

Although top bars 110 of the hive frames are readily accessible from the top, pulling a frame by the top bar using previously available means was difficult since the bees glue the frames to one another and to the hive itself. Therefore, attempts to lift a hive frame by its top bar using previously available means often compromised structural integrity of the frame.

Sidebars of frames (visible here as posts 126) are less accessible since posts 126 are glued to one another (see glue joints 128 in FIG. 1).

In some embodiments, a gripper includes a first set of protrusions, that face the top bar of the frame as the gripper is lowered to the level of the top bare. In some exemplary embodiments of the invention, this first set of protrusions is used for separating frames from one another by pushing frames sideways, e.g., as illustrated by 1310 (FIG. 12). In some embodiments, once space is created between frames, the gripper is further lowered so that a second portion of the gripper faces the sidebars of the hive frame. This second portion is used to engage and retain the sidebars, contributing to an ability to lift the frame using the sidebars instead of or in addition to, the top bar. According to these embodiments, engagement of the side bars of a frame contributes to a reduced risk of compromising structural integrity of the frame during lifting.

Referring concurrently to FIGS. 10a, 10b and 10c, depicted exemplary motorized clamp 1100 is equipped with a pair of downward facing jaws 1110. In the depicted embodiment, each of the jaws 1110 includes a first downward extending member 1112 with a length greater than a thickness (t) of a top bar of a hive frame and a second member 1114, perpendicular to first member 1112 and extending from an outer surface thereof having a notch 1116 sized to engage an outer edge of a sidebar of the hive frame. In the depicted embodiment, notch 1116 is formed by a side 1118 of first member 1112 and a block 1120 extending from an inner side of second member 1114.

In some exemplary embodiments of the invention, block 1120 is sized to touch an ear 114 of top bar 110 and/or other parts of the top bar when the outer edge of the side bar is engaged by notch 1116.

In the depicted embodiment, clamp 1100 includes a twin lead screw 1130 in operative connection with each jaw in said pair of downward facing jaws.

In other exemplary embodiments of the invention, twin lead screw 1130 is replaced by rocker arms (as depicted in FIG. 4) and/or by a linear actuator mechanism (as depicted in FIG. 5) and/or by a moving ring actuator (FIG. 6).

Alternatively or additionally, in some embodiments the mechanisms or assemblies shown in FIG. 2, FIG. 3, FIG. 4, FIG. 5, FIG. 6, FIG. 10a, FIG. 10b, and FIG. 10c can be raised and lowered. For example, the raising/lowering function is provided by attaching the mechanisms to a robotic arm in some embodiments. In some embodiments, when raised, these mechanisms or assemblies are moveable above a set of hive frames. In some embodiments this motion contributes to an ability to position the relevant mechanism (e.g. the mechanism of FIG. 6) above a target hive frame. In this way, lowering of mechanism 600 positions protrusions 632 appropriately so that when a distance between them is increased, they will push a sidebar or top bar of an adjacent frame. Similarly, in this way lowering of mechanism 600 positions jaws 640 to grip a sidebar or top bar of the target frame.

In addition, the mechanisms or assemblies shown in FIG. 2, FIG. 3, FIG. 4, FIG. 5, FIG. 6, FIG. 10a, FIG. 10b, and FIG. 10c can be linearly translated along a top bar of a hive frame. For example, mechanism 600 can be moved along a top bar of a frame such that jaws 640 and/or ridges 642 are positioned to grip the frame by its top bar or by its sidebar.

Exemplary System

FIG. 11a is an additional schematic representation of a hive frame manipulation system, indicated generally as 1200, according to some embodiments of the invention.

In the depicted embodiment, system 1200 includes a beam 1210 with two motorized clamps 1216 positioned thereupon. In the depicted embodiment, each clamp 1216 has a pair of downward facing jaws 1212 and a clamp motor 1214. In some embodiments clamp motor 1214 is operatively connected to jaws 1212 to regulate a distance between them and/or to allow jaws 1212 to provide an inward and/or outward force of about 500 newtons.

In the depicted embodiment, system 1200 includes a motorized drive train 1220 operatively connected to beam 1210 to cause linear translation of beam 1210 with 2 degrees of freedom. In some embodiments drive train 1220 provides 3 degrees of freedom to beam 1210.

FIG. 11a also depicts a controller 1230 programmed to position beam 1210 over a hive frame, lower beam 1210 until jaws 1212 enter spaces (of various types as described hereinabove) on either side of the frame, decrease a distance between jaws 1212 in each of motorized clamps 1216 until jaws 1212 engage and retain the hive frame and raise beam 1210.

In the depicted embodiment, system 1200 includes two pairs of downward facing mechanical rods 1240 protruding from a bottom face of beam 1210; and a motor 1242 connected to a drive train that increases a distance between rods in each pair. In some exemplary embodiments of the invention, motor 1242 transmits a force of about 500 newtons via rods 1240.

In some embodiments controller 1230 is programmed to increase a distance between jaws 1212 in each of motorized clamps 1216 prior to decreasing the distance. In some embodiments increasing a distance between jaws 1212 allows them to perform the function of rods 1240, obviating a need for rods 1240.

In some exemplary embodiments of the invention, system 1200 includes a twin lead screw in operative connection with each of jaws 1212 as depicted in FIG. 3 and/or FIG. 10a. Alternatively or additionally, in some embodiments system 1200 includes rocker arms in operative connection with each of jaws 1212 as depicted in FIG. 4. Alternatively or additionally, in some embodiments system 1200 includes a linear actuator mechanism in operative connection with each of jaws 1212 as depicted in FIG. 5. Alternatively or additionally, in some embodiments system 1200 includes a ring actuator mechanism in operative connection with each of jaws 1212 as depicted in FIG. 6.

Alternatively or additionally, in some embodiments system 1200 includes a shaker mechanism 1250 operatively connected to clamps 1216. According to these embodiments, shaker mechanism 1250 is under operative control of controller 1230.

In some exemplary embodiments of the invention, in which motor drive train 1220 has 3 degrees of freedom, the drive train responds to output signals from controller 1230 to transfer the hive frame to/from a processing unit. According to various exemplary embodiments of the invention, the processing unit includes an analytic module and/or a treatment module and/or a centrifuge.

FIG. 11b is a diagram of computer system architecture according to some embodiments of the invention. In the depicted embodiment, controller 1230 reads and executes code 1262 stored in memory 1260. Alternatively or additionally, in some embodiments controller 1230 is in communication with a data storage system 1250 containing frame data 1252. Input/Output (I/O) 1270 are also available to the controller. According to various exemplary embodiments of the invention code 1262 includes instructions for transferring frames defined by frame data 1252 to an analytic module and/or a treatment module and/or a centrifuge as described above in the context of FIG. 9.

Exemplary “Cover Per Frame” Configurations

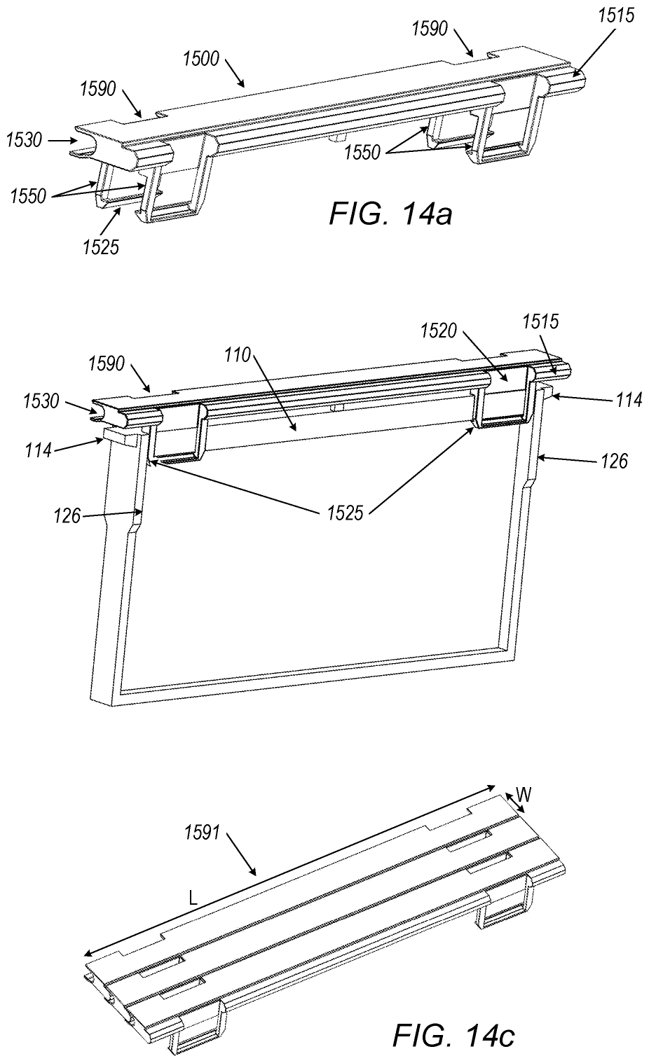

FIG. 13 is a side perspective view from above of a cover for an individual hive frame according to an exemplary embodiment of the invention.

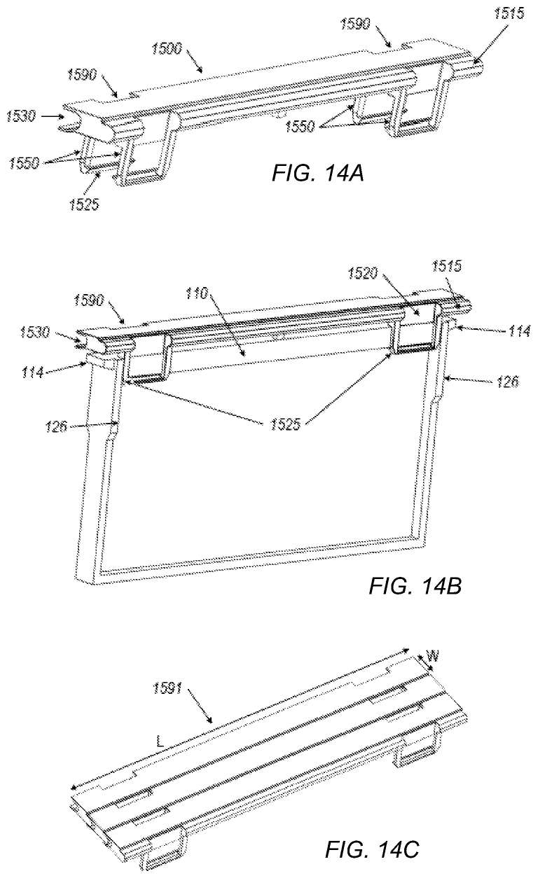

FIG. 14a is a side perspective view from above of a cover for an individual hive frame according to another exemplary embodiment of the invention.

FIG. 14b is a side perspective view from above of a cover for an individual hive frame according to the embodiment of FIG. 14a attached to a hive frame.

FIG. 14c is a perspective view from above of a series of covers for individual hive frames according to the embodiment of FIG. 14a engaging one another.

Referring now to FIG. 13 and FIG. 14c concurrently, some exemplary embodiments of the invention relate to a bee hive cover comprising a plurality 1591 of cover per frame (CPF) units (as seen in FIG. 14c), each unit having:

a length (L) sufficient to span a width of the beehive; and

a width (W) corresponding to a width of a hive frame of the beehive.

In some exemplary embodiments of the invention, the length (L) is about 19 inches and/or the width (W) is about 11/16 of an inch. The number of CPF units (1400 or 1500) in plurality 1591 corresponds to a number of hive frames in said beehive. In some exemplary embodiments of the invention, each CPF unit (1400 or 1500) includes downward extension at each end. In some embodiments these downward extensions contribute to a tendency of the CPF unit to remain in a correct position. In the depicted embodiment, each CPF unit includes at least one pair of indentations (e.g. 1430; 1590; 1420) on an upper edge thereof. In the depicted embodiment, some CPF units include two pairs of parallel indentations positioned proximal to the two ends of the CPF unit (see 1430 in FIGS. 13 and 1590; 1520 in FIGS. 14a and 14 b). In some embodiments pairs of indentations contribute an ability of a mechanical device to engage and manipulate the individual CPF unit. Examples of mechanical devices which engage and manipulate the individual CPF units are presented hereinabove (e.g. 400 (FIG. 4); 500 (FIG. 5); and 600 (FIG. 6).

In the depicted embodiment, the CPF unit includes pairs of parallel downward extending tabs (e.g. 1450; 1550) designed and configured to engage and retain opposite sides of a top bar of a hive frame covered by the CPF unit. In the depicted embodiment, snap to fit retention grooves (e.g. 1420; 1525) contribute to an ability of the tabs to engage and retain a top bar 110 of a hive frame.

In some exemplary embodiments of the invention, the parallel downward extending tabs (1450; 1550) are positioned below the parallel indentations (1430, 1590, 1520). According to these embodiments, the tabs impede bees from exiting the hive through the indentions when the individual CPF units are in a closed position on top of the hive.

Referring now specifically to FIGS. 14a, 14b and 14c, in some exemplary embodiments of the invention, each CPF unit includes a convex ridge 1515 extending along at least a portion of a length of one axial edge and a corresponding concave groove 1530 extending along at least a portion of a length of an opposite axial edge. According to these embodiments, when the individual CPF units are assembled into a contiguous cover, the convex ridge 1515 of one unit is seated in the convex groove 1530 of an adjacent unit as seen in FIG. 14c.

Alternatively or additionally, in some embodiments each CPF unit includes an elastic flange along at least one axial edge thereof. In some exemplary embodiments of the invention, each CPF unit comprises an elastic flange along both axial edges thereof. In some exemplary embodiments of the invention, convex ridge and/or convex groove 1530 comprise elastic material and serve as the flanges. According to these embodiments, the elastic flange contributes to formation of a seal between adjacent individual CPF units assembled into a contiguous cover.

In some exemplary embodiments of the invention, when first and second CPFs (e.g. 1400 or 1500) are placed adjacent to one another on a beehive they prevent passage of bees between CPFs. A series of adjacent CPFs form a contiguous cover of the beehive (i.e. the top side of the hive).

In some exemplary embodiments of the invention, each CPF includes elements that contribute to the ability of a gripper (e.g. 400, 500 and 600 in FIGS. 4, 5 and 6 respectively) to grip and extract the CPF and the respectively connected hive frame from the beehive.

In some exemplary embodiments of the invention, when first and second CPFs are placed adjacent to one another in the beehive, a notch included in the first CPF and a notch included

in the second CPF form a cavity (space) accessible to a gripper and the cavity is inaccessible to bees in the beehive.

In some exemplary embodiments of the invention, CPFs include a protrusion (e.g. 1515) and a housing (e.g. 1530) such that when adjacently placed in the beehive, a protrusion (e.g. 1515) of a first CPF is at least partially included in a housing (e.g. 1530) of a second, adjacent CPF.

In some exemplary embodiments of the invention, a size of a surface created by a plurality of CPFs is varied by varying an amount of inclusion of a protrusion of a first CPF in a housing of a second, adjacent CPF.

Exemplary Communication Links

FIG. 11a depicts controller 1230 schematically. According to various exemplary embodiments of the invention controller 1230 is connected to other system parts either via wires or via a wireless connection protocol (e.g. as depicted in FIG. 11b).

Wired connections may include, but are not limited to: USB connections, RCA plugs, banana plugs, pole jack connectors and coaxial connectors.

Wireless connections may include, but are not limited to connections relying on one or more of the following technologies: Bluetooth, Wi-Fi, Infrared, UV, Microwave, radio (e.g. AM or SW) and ultrasound.

It is expected that during the life of this patent many actuator types and/or drive train types will be developed and the scope of the invention includes all such new technologies a priori.

As used herein the term “about” refers to ±10%.

Although the invention has been described in conjunction with specific embodiments thereof, it is evident that many alternatives, modifications and variations will be apparent to those skilled in the art. Accordingly, the application embraces all such alternatives, modifications and variations that fall within the broad scope of the appended claims.

Specifically, a variety of numerical indicators have been utilized. It should be understood that these numerical indicators could vary even further based upon a variety of engineering principles, materials, intended use and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are illustrative in nature and do not limit the scope of the invention which is defined solely by the following claims.

Each recitation of an embodiment of the invention that includes a specific feature, part, component, module or process is an explicit statement that additional embodiments of the invention not including the recited feature, part, component, module or process exist.

Alternatively or additionally, various exemplary embodiments of the invention exclude any specific feature, part, component, module, process or element which is not specifically disclosed herein.

All publications, references, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

1. A method comprising:
(a) lowering two pairs of mechanical rods into inter-frame spaces on each side of a single hive frame in a beehive;
(b) decreasing a distance between downward facing jaws of a motorized clamp until said jaws engage and retain the single hive frame; and
(c) lifting said motorized clamp.

2. A method according to claim 1, wherein said rods are provided as downward facing jaws of a motorized clamp.

3. A method according to claim 1, comprising increases a distance between the rods to separate the single frame from adjacent frames.

4. A method according to claim 1, comprising:
shaking the hive frame while the jaws of said motorized clamp engage said hive frame.

5. A method according to claim 1, comprising using a robotic arm attached to said at least one pair of jaws to transfer said hive frame to a processing unit.

6. A method according to claim 5, wherein said processing unit includes one or more members of the group consisting of an analytic module, a treatment module and a centrifuge.

7. A method according to claim 5, comprising using a robotic arm attached to said at least one pair of jaws to transfer said hive frame from said processing unit back to said beehive.

8. A method according to claim 1, wherein said inter-frame spaces are between one of:
adjacent ears of top bars of hive frames in the beehive,
adjacent top bars of hive frames proximal to side bars of said hive frames in the beehive, and
central portions of top bars of said hive frames.

9. A method according to claim 1, comprising using one of: a twin lead screw, a rocker arm, linear actuator and a ring actuator for and decreasing said distance.

10. A method according to claim 1, comprising:
shaking the hive frame while the jaws of said motorized clamp engage said hive frame.

11. A system comprising:
a plurality of honeycomb frames included in a habitat;
a robotic arm including at least one pair of jaws; and
a controller adapted to cause the robotic arm to:
lower the at least one pair of jaws into an inter-frame space on each side of a single hive frame;
decrease a distance between the least one pair of jaws until said jaws engage and retain the single hive frame; and
lift said jaws and the engaged hive frame.

12. The system of claim 11, wherein the controller is further adapted to:
Shake the hive frame while the jaws of said motorized clamp engage said hive frame;
transfer said hive frame to a processing unit; and
transfer said hive frame from the processing unit to the habitat.

13. A bee hive cover comprising:
a plurality of cover per frame (CPF) units, each unit having:
a length sufficient to span a width of said beehive; and
a width corresponding to a width of a hive frame of said beehive;
wherein a number of units in said plurality corresponds to a number of hive frames in said beehive.

14. A bee hive cover according to claim 13, wherein each CPF unit comprises:
a downward extension at each end.

15. A bee hive cover according to claim 13, wherein each CPF unit comprises:
at least one pair of indentations on an upper edge thereof.

16. A bee hive cover according to claim 15, wherein some CPF units comprise:
two pairs of parallel indentations on opposite edges thereof positioned proximal to the two ends of said CPF unit.

17. A bee hive cover according to claim 13, wherein each CPF unit comprises:
pairs of parallel downward extending tabs designed and configured to engage and retain opposite sides of a top bar of a hive frame covered by said CPF unit.

18. A bee hive cover according to claim 13, wherein each CPF unit comprises:
a convex ridge extending along at least a portion of a length of one axial edge; and
a corresponding concave groove extending along at least a portion of a length of an opposite axial edge.

19. A bee hive cover according to claim 13, wherein each CPF unit comprises:
an elastic flange along at least one axial edge thereof.

20. A bee hive cover according to claim 19, wherein each CPF unit comprises:
an elastic flange along both axial edges thereof.
